(19) United States
(12) Patent Application Publication
(10) Pub. No.: US 2026/0018062 A1
(43) Pub. Date: Jan. 15, 2026

(54) TRAVEL SUPPORT DEVICE, TRAVEL SUPPORT METHOD, AND NON-TRANSITORY COMPUTER-READABLE RECORDING MEDIUM

(71) Applicants: TOYOTA JIDOSHA KABUSHIKI KAISHA, Toyota-shi (JP); DENSO CORPORATION, Kariya-city (JP)

(72) Inventors: Soichi YOSHINO, Ichikawa-shi (JP); Ryuta HASHIMOTO, Tokyo-to (JP); Takahiro SETA, Yokohama-shi (JP); Takuo KANEKO, Tokyo-to (JP)

(73) Assignees: TOYOTA JIDOSHA KABUSHIKI KAISHA, Toyota-shi (JP); DENSO CORPORATION, Kariya-city (JP)

(21) Appl. No.: 19/233,612

(22) Filed: Jun. 10, 2025

(30) Foreign Application Priority Data
Jul. 9, 2024 (JP) 2024-110223

(51) Int. Cl. G08G 1/00; B60W 60/00

(52) U.S. Cl. CPC G08G 1/22; B60W 60/001; B60W 2520/10; B60W 2552/10; B60W 2554/406; G06Q 2240/00

(57) ABSTRACT

A travel support device supports vehicle traveling. The travel support device includes one or more processors. The one or more processors are configured to execute travel management processing when a target vehicle is traveling on a road having a specific lane in which a specific type of vehicle preferentially travels. The target vehicle is of a different type from the specific type. The travel management processing includes travel permission processing of permitting the target vehicle to travel in the specific lane when the target vehicle is traveling in a vehicle train being a train of vehicles that perform platooning, and entry inhibition processing of inhibiting entry of the target vehicle into the specific lane when the target vehicle is not traveling in the vehicle train.

### CROSS-REFERENCES TO RELATED APPLICATION

The present disclosure claims priority under 35 U.S.C. § 119 to Japanese Patent Application No. 2024-110223, filed on Jul. 9, 2024, which is incorporated herein by reference in its entirety.

### BACKGROUND

### Technical Field

The present disclosure relates to a technique for supporting vehicle traveling.

### Background Art

JP 2020-042649 A discloses a driving assistance device that helps vehicles merge into a vehicle group including a plurality of vehicles traveling in a row.

JP 2023-033359 A discloses a vehicle management device that acquires a congestion degree of a road on which platooning is performed and sets a reference of the number of vehicles that form the platooning or a length of the platooning based on the acquired congestion degree. Further, JP 2023-037371 A discloses a power supply system that contributes to expanding the application of convoy travel by proving an incentive to a vehicle to travel as the lead vehicle of the convoy.

### SUMMARY

When a vehicle of a type (e.g., a passenger car) that is different from a specific type of vehicle (e.g., a truck or a bus) is traveling in a vehicle train that performs platooning on a road having a specific lane (e.g., a dedicated lane or a priority lane) in which a specific type of vehicle preferentially travels, a situation is assumed in which a travel lane other than the specific lane is congested but only the specific lane is vacant. This kind of situation can also be considered as potentially causing waste in the traffic capacity of the entire road.

A travel support device according to the present disclosure supports vehicle traveling. The travel support device includes one or more processors. The one or more processors are configured to execute travel management processing when a target vehicle is traveling on a road having a specific lane in which a specific type of vehicle preferentially travels. The target vehicle is of a different type from the specific type. The travel management processing includes travel permission processing of permitting the target vehicle to travel in the specific lane when the target vehicle is traveling in a vehicle train being a train of vehicles that perform platooning, and entry inhibition processing of inhibiting entry of the target vehicle into the specific lane when the target vehicle is not traveling in the vehicle train.

A travel support method according to the present disclosure supports vehicle traveling. The travel support method, which is executed by a computer, includes executing travel management processing when a target vehicle is traveling on a road having a specific lane in which a specific type of vehicle preferentially travels. The target vehicle is of a different type from the specific type. The travel management processing includes travel permission processing of permitting the target vehicle to travel in the specific lane when the target vehicle is traveling in a vehicle train being a train of vehicles that perform platooning, and entry inhibition processing of inhibiting entry of the target vehicle into the specific lane when the target vehicle is not traveling in the vehicle train.

A non-transitory computer-readable recording medium according to the present disclosure stores a travel support program executed by a computer for supporting vehicle traveling. The travel support program causes the computer to execute travel management processing when a target vehicle is traveling on a road having a specific lane in which a specific type of vehicle preferentially travels. The target vehicle is of a different type from the specific type. The travel management processing includes travel permission processing of permitting the target vehicle to travel in the specific lane when the target vehicle is traveling in a vehicle train being a train of vehicles that perform platooning, and entry inhibition processing of inhibiting entry of the target vehicle into the specific lane when the target vehicle is not traveling in the vehicle train.

According to the present disclosure, even the target vehicle is of a type different from the specific type is permitted to travel in the specific lane on condition that the target vehicle is traveling in the vehicle train. Therefore, the entire road can be effectively used without disturbing the order.

### BRIEF DESCRIPTION OF THE DRAWINGS

FIG. 1 is a conceptual diagram used to describe an overview of a travel support system according to an embodiment;

FIG. 2 is a block diagram showing an example of a configuration of a target vehicle and a management server according to an embodiment;

FIG. 3 is a flowchart used to describe vehicle train formation support processing according to an embodiment;

FIG. 4 is a flowchart showing an example of a flow of the vehicle train formation support processing in step S3;

FIG. 5 is a supplementary diagram regarding a degree of match Dm2 of destination preference information;

FIG. 6 is a flowchart used to describe an overview of vehicle train information provision processing according to an embodiment;

FIG. 7 is a diagram used to describe an overview of an issue during traveling of the target vehicle and travel management processing as a countermeasure against the issue;

FIG. 8 is a flowchart showing an example of a flow of the travel management processing according to an embodiment;

FIG. 9 is a flowchart showing a first example of entry inhibition processing in step S34;

FIG. 10 is a flowchart showing a second example of the entry inhibition processing in step S34;

FIG. 11 is a flowchart showing a third example of the entry inhibition processing in step S34;

FIG. 12 is a flowchart showing a fourth example of the entry inhibition processing in step S34;

FIG. 13 is a diagram used to describe a further issue during traveling of the target vehicle and an execution mode of the travel management processing as a countermeasure against the further issue;

FIG. 14 is a flowchart showing another example of a flow of the travel management processing according to an embodiment;

FIG. 15 is a flowchart used to describe congestion reduction processing according to an embodiment;

FIG. 16 is a flowchart used to describe first incentive provision processing according to an embodiment; and

FIG. 17 is a flowchart used to describe second incentive provision processing according to an embodiment.

### DETAILED DESCRIPTION

Embodiments of the present disclosure will be described with reference to the accompanying drawings.

### 1. Overview of Travel Support System

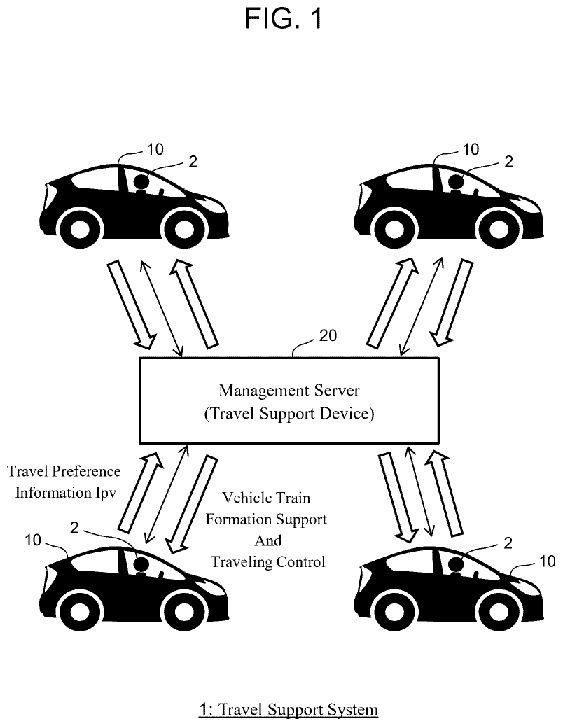

FIG. 1 is a conceptual diagram used to describe an overview of a travel support system 1 according to the present embodiment. The travel support system 1 is a system that supports vehicle traveling. The travel support system 1 includes a plurality of vehicles 10 and a management server (i.e., central server) 20. Each of the plurality of vehicles 10 is the target of the vehicle traveling support (“target vehicle” according to the present disclosure) by the travel support system 1.

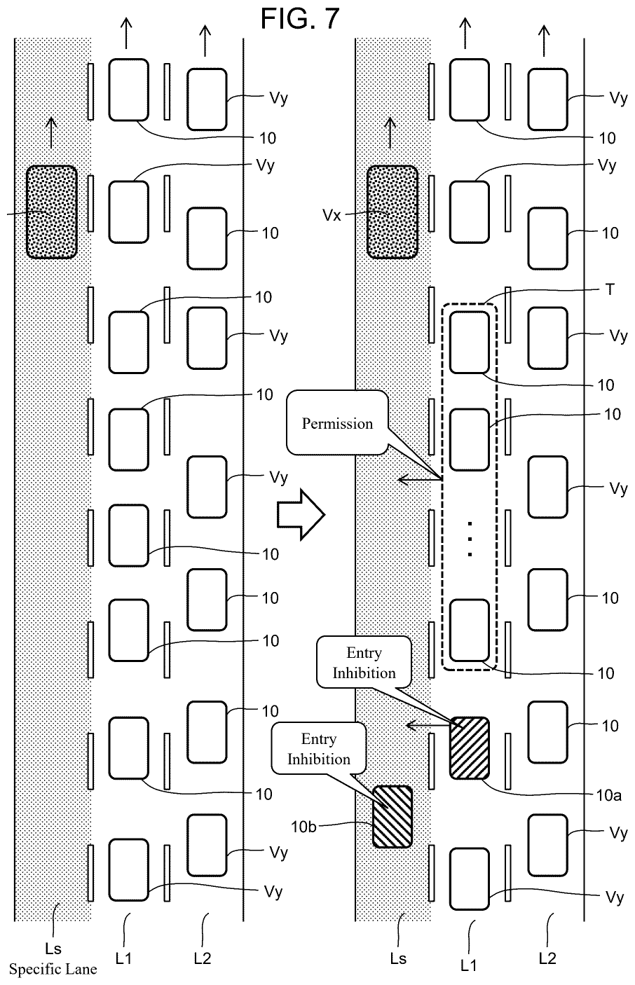

The management server 20 can communicate with each of the plurality of vehicles 10. In the present embodiment, the management server 20 supports the vehicles 10 to form a vehicle train (i.e., a vehicle queue or a convoy) T (for example, see FIG. 7) for platooning. That is, the “vehicle train” mentioned here refers to a train of vehicles that perform platooning on a road. More specifically, this vehicle train formation support by the management server 20 may be, for example, support of formation of a vehicle train by vehicles 10 having similar preferences (travel preferences) of the occupants 2 regarding vehicle traveling among the plurality of vehicles 10 (see the “vehicle train formation support processing” described below). Also, the management server 20 controls the traveling of the formed vehicle train T (i.e., the platooning). For example, the management server 20 controls acceleration, deceleration, and lane change of the formed vehicle train T. In addition, the management server 20 corresponds to an example of the “travel support device” according to the present disclosure.

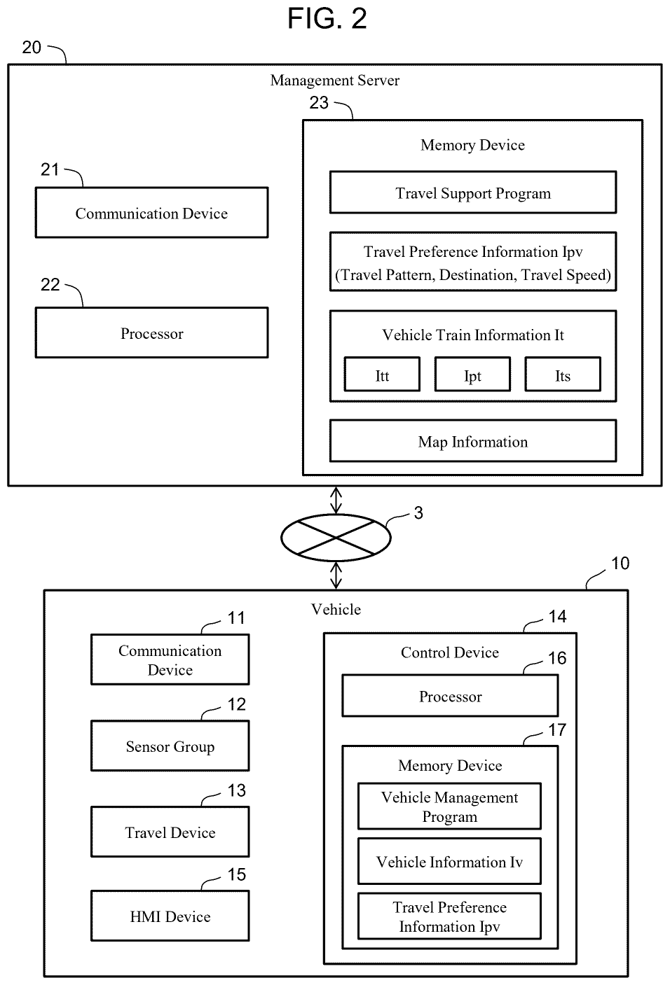

The vehicle 10 may be a manually driven vehicle in which the occupant 2 drives the vehicle 10 as a driver. In the example of the manually driven vehicle, the management server 20 transmits an instruction regarding the platooning (for example, an instruction of travel speed, acceleration, deceleration, or lane change of the vehicle train T) to, for example, an HMI device 15 (see FIG. 2) of each of the vehicles 10 constituting the vehicle train T. As a result, the driver 2 of each vehicle 10 drives the subject vehicle 10 in accordance with the instruction. Further, the instruction may be transmitted only to the lead vehicle 10 of the vehicle train T, for example. As a result, the driver 2 of the lead vehicle 10 drives the lead vehicle 10 in accordance with the instruction, and the driver 2 of each of one or more following vehicles 10 drives the subject vehicle 10 so as to follow the preceding vehicle 10 (including the lead vehicle 10) of the subject vehicle 10. In addition, the “manually driven vehicle” referred to herein may include, for example, a “driving assistance vehicle” having an automated driving function (i.e., driving assistance function) that enables partial automatic travel control (i.e., advanced driving assistance) of level 2 or lower in the automatic driving level defined by the Society of Automotive Engineers (SAE) in the United States. Also, in the example of the driving assistance vehicle, the driver 2 may use driving assistance control (for example, adaptive cruise control (ACC), lane following assistance control) when causing the subject vehicle 10 to follow the preceding vehicle 10.

Moreover, the vehicle 10 may be an automated driving vehicle that can perform automatic traveling. More specifically, the “automated driving vehicle” described herein has an automated driving function of level 3 or higher in the automated driving level described above. In the example of the automated driving vehicle, the management server 20 remotely controls the platooning of the individual vehicles 10 constituting the vehicle train T, for example. More specifically, the management server 20 transmits an instruction related to the platooning to a control device 14 (see FIG. 2) of each vehicle 10, for example. As a result, the control device 14 of each vehicle 10 controls a travel device 13 (see FIG. 2) in accordance with the instruction. Alternatively, the management server 20 may remotely control the travel device 13 of each vehicle 10 directly. Furthermore, the remote control of the platooning of the vehicles 10 by the management server 20 may be performed, for example, only for the lead vehicle 10 in the vehicle train T. In this example, the control device 14 of each of one or more following vehicles 10 controls the automated driving of the subject vehicle 10 so as to follow the preceding vehicle 10 (including the lead vehicle 10) of the subject vehicle 10.

FIG. 2 is a block diagram showing an example of the configuration of the vehicle 10 and the management server 20 according to the present embodiment.

As shown in FIG. 2, the vehicle 10 includes a communication device 11, sensor group 12, the travel device 13, the control device 14, and the human machine interface (HMI) device 15.

The communication device 11 communicates with the outside of the vehicle 10. The communication device 11 performs wireless communication with the management server 20 via a communication network 3, for example. The communication device 11 may include a vehicle-to-vehicle communication device that enables communication between the subject vehicle 10 and a surrounding vehicle 10 (i.e., vehicle-to-vehicle communication (V2V)).

The sensor group 12 includes a recognition sensor, a vehicle state sensor, and a position sensor, for example. The recognition sensor recognizes (detects) a situation around the vehicle 10. Examples of the recognition sensor include a camera, a laser imaging detection and ranging (LIDAR), and a radar. The vehicle state sensor detects the state of the vehicle 10. Examples of the vehicle state sensor include a speed sensor, an acceleration sensor, a yaw rate sensor, and a steering angle sensor. The position sensor detects a position and an orientation of the vehicle 10. For example, the position sensor includes a global navigation satellite system (GNSS) receiver.

The travel device 13 is a device that operates the vehicle 10. The travel device 13 includes a drive device, a brake device, and a steering device. The drive device includes, for example, at least one of an electric motor and an internal combustion engine for driving (accelerating) the vehicle 10. The brake device includes a brake actuator for braking (decelerating) the vehicle 10. The steering device includes an electric motor for turning the wheels of the vehicle 10.

The control device 14 controls the vehicle 10. The control device 14 includes one or more processors 16 (hereinafter, simply referred to as a processor 16) and one or more memory devices 17 (hereinafter, simply referred to as a memory device 17). The processor 16 executes various kinds of processing. Examples of the processor 16 include a general-purpose processor, a special-purpose processor, a central processing unit (CPU), a graphics processing unit (GPU), an application specific integrated circuit (ASIC), and a field-programmable gate array (FPGA). The processor 16 may also be referred to as processing circuitry. The memory device 17 stores various kinds of information. Examples of the memory device 17 include a volatile memory, a nonvolatile memory, a hard disk drive (HDD), and a solid state drive (SSD). The processor 16 executes a vehicle management program (computer program) including a vehicle control program. The vehicle management program is stored in the memory device 17. Alternatively, the vehicle management program may be recorded in a non-transitory computer-readable recording medium or may be provided via the communication network 3. The function of the control device 14 may be realized by cooperation between the processor 16 that executes the vehicle management program and the memory device 17.

The various kinds of information stored in the memory device 17 includes vehicle information Iv and travel preference information Ipv. The vehicle information Iv is information on the vehicle 10, and includes, for example, vehicle state information, surrounding situation information, position information, vehicle type information, and travel distance information. The vehicle state information is information indicating the state of the vehicle 10, such as the vehicle speed (travel speed), the acceleration, and the yaw rate, and is acquired using, for example, the sensor group 12 (vehicle state sensor). The surrounding situation information is information indicating the surrounding situation of the vehicle 10, and is acquired using, for example, the sensor group 12 (recognition sensor). The surrounding situation information may include object information regarding objects (for example, other vehicles, white lines, traffic lights, signs, roadside structures) around the vehicle 10. The position information is information indicating the position and the orientation of the vehicle 10, and is acquired using, for example, the sensor group 12 (position sensor). The vehicle type information is information indicating the type of the vehicle 10 (for example, passenger car, truck, or bus). The travel preference information Ipv will be described below.

The HMI device 15 is an interface between the vehicle 10 and the occupant 2 and is mounted on the vehicle 10, for example. Specifically, the HMI device 15 includes an output unit that outputs information to the occupant 2 and an input unit (for example, a touch panel, an operation button, an operation switch, a microphone) to which information is input by the occupant 2. The output unit includes, for example, a display device and a speaker. The display device is, for example, a display (for example, a meter panel) mounted on an instrument panel of the vehicle 10 or a head-up display (HUD) that displays information on a windshield of the vehicle 10. The HMI device 15 notifies the occupant 2 of various kinds of information based on an instruction from the control device 14. Also, the HMI device 15 transmits information input by the occupant 2 to the control device 14. The HMI device 15 may have a navigation function of guiding the traveling of the vehicle 10. In addition, a mobile device (for example, a smartphone or a tablet terminal) of the occupant 2 may be communicably connected to the control device 14 in a wired or wireless manner, for example, and may function as the HMI device 15.

As illustrated in FIG. 2, the management server 20 includes a communication device 21, one or more processors 22 (hereinafter, simply referred to as a processor 22), and one or more memory devices 23 (hereinafter, simply referred to as a memory device 23). The communication device 21 performs wireless communication with the vehicle 10 via the communication network 3.

The processor 22 executes various kinds of processing for supporting the platooning of the plurality of vehicles 10. Examples of the processor 22 include a CPU, a GPU, an ASIC, and an FPGA. The processor 22 may also be referred to as processing circuitry. The memory device 23 stores various kinds of information. Examples of the memory device 23 include a volatile memory, a nonvolatile memory, an HDD, and an SSD. The processor 22 executes a travel support program (computer program). The travel support program is stored in the memory device 23. Alternatively, the travel support program may be recorded in a non-transitory computer-readable recording medium or may be provided via the communication network 3. The function of the management server 20 may be realized by cooperation between the processor 22 that executes the travel support program and the memory device 23.

The various kinds of information stored in the memory device 23 includes the travel preference information Ipv, vehicle train information It, and map information. The travel preference information Ipv is acquired from each vehicle 10. The vehicle train information It includes, for each vehicle train T, a vehicle train identification (ID), vehicle train travel information Itt, travel preference information Ipt, and vehicle train surrounding situation information Its, for example. The vehicle train travel information Itt is information indicating the traveling state of the vehicle train T, and includes, for example, the position, the travel speed, and the number of lane changes of the vehicle train T. The vehicle train travel information Itt can be acquired based on the vehicle information Iv from each vehicle 10, for example. The travel preference information Ipt is information indicating the travel preference of the vehicle train T, and can be specified by, for example, a method described in step S11 described below. The vehicle train surrounding situation information Its is information indicating the surrounding situation of the vehicle train T, and includes, for example, information of surrounding vehicles of the vehicle train T and road traffic information (for example, traffic density, traffic volume, congestion, traffic regulation, and traffic accidents). The vehicle train surrounding situation information Its can be acquired based on, for example, the vehicle information Iv (surrounding situation information) from each vehicle 10 or information from an external system (for example, a road traffic information providing system). The map information includes information (for example, road shape and lane information) of a road on which the vehicle train T travels. More specifically, the lane information included in the road information includes information on a “specific lane Ls”. The specific lane Ls is a travel lane (for example, a dedicated lane or a priority lane) for allowing a “specific type of vehicle” to preferentially travel. The specific type of vehicle is a vehicle of a type different from the type of the vehicle 10 which is the “target vehicle”. In one example, the specific type of vehicle is a truck or a bus, and the vehicle 10 is a passenger car.

### 2. Processing Related to Vehicle Traveling Support

### 2-1. Vehicle Train Formation Support Processing

In order to support the formation of a vehicle train, the management server 20 acquires the “travel preference information Ipv” from each of the plurality of vehicles 10 that are targets of the vehicle traveling support. Then, in the vehicle train formation support processing, the management server 20 supports the formation of the vehicle train T in which vehicles 10 having similar travel preferences among the plurality of vehicles 10 perform the platooning, based on the acquired travel preference information Ipv.

The travel preference information Ipv is information indicating the preference of the occupant 2 (e.g., the driver) regarding the traveling of the vehicle 10. In detail, in one example, the travel preference information Ipv includes travel pattern preference information Ipv1 on a desired travel pattern, destination preference information Ipv2 on a desired destination, and travel speed preference information Ipv3 on a desired travel speed. The travel pattern can also be referred to as a travel mode. In another example, the travel preference information Ipv may include only one or two of the travel pattern preference information Ipv1, the destination preference information Ipv2, and the travel speed preference information Ipv3.

### (Desired Travel Pattern)

The desired travel pattern may include, for example, any two or more of a “travel efficiency priority pattern”, a “safety priority pattern”, a “fuel efficiency priority pattern”, and an “on-time observance priority pattern” as candidates for selection by the occupant 2. The travel efficiency priority pattern is a pattern that focuses on traveling to reach a destination earlier (for example, aggressively performing overtaking). The safety priority pattern is a pattern that focuses on traveling to arrive at a destination more safely (for example, allowing an arrival delay of less than a designated time). The fuel efficiency priority pattern is a pattern that focuses on low fuel-efficient traveling. The on-time observance priority pattern is a pattern that focuses on traveling on time (for example, arriving at each location at a designated point of time as in a route bus).

Moreover, the desired travel pattern may be specified by at least one of the preference of a “lane change frequency” and the preference of a “speed range”, for example. The lane change frequency mentioned here is the number of lane changes per designated time, and the speed range is the magnitude of the allowable speed difference with respect to a target speed set when the vehicle 10 is traveling.

The travel pattern preference information Ipv1 may be acquired in advance in each of the vehicles 10 by the following method. That is, for example, the control device 14 of each vehicle 10 may request the occupant 2 to select (input) a desired travel pattern through the HMI device 15. More specifically, for example, the control device 14 may request the occupant 2 to select a desired travel pattern from designated candidates (for example, the travel efficiency priority pattern and the safety priority pattern). Alternatively, the control device 14 may request the occupant 2 to input a numerical value that matches the preference of the occupant 2 from among numerical values of the lane change frequency determined in advance, for example. This is the same for the speed range.

Furthermore, the control device 14 stores the desired travel pattern selected (input) by the occupant 2 as described above in the memory device 17 as the travel pattern preference information Ipv1. Alternatively, the control device 14 may specify the desired travel pattern based on the travel record of the vehicle 10 driven by the occupant 2 in the past and store the specified desired travel pattern in the memory device 17 as the travel pattern preference information Ipv1. In addition, machine learning may be used to specify the desired travel pattern in this manner.

Additionally, it can be said that the desired travel pattern described above indicates the priority of the occupant 2 for the traveling (driving) of the vehicle 10.

### (Desired Destination)

The destination preference information Ipv2 may be acquired in advance in each of the vehicles 10 by the following method. That is, for example, the control device 14 may request the occupant 2 to select (input) a desired destination through the HMI device 15. When the desired destination is input to the HMI device 15, the control device 14 stores the input desired destination in the memory device 17 as the destination preference information Ipv2.

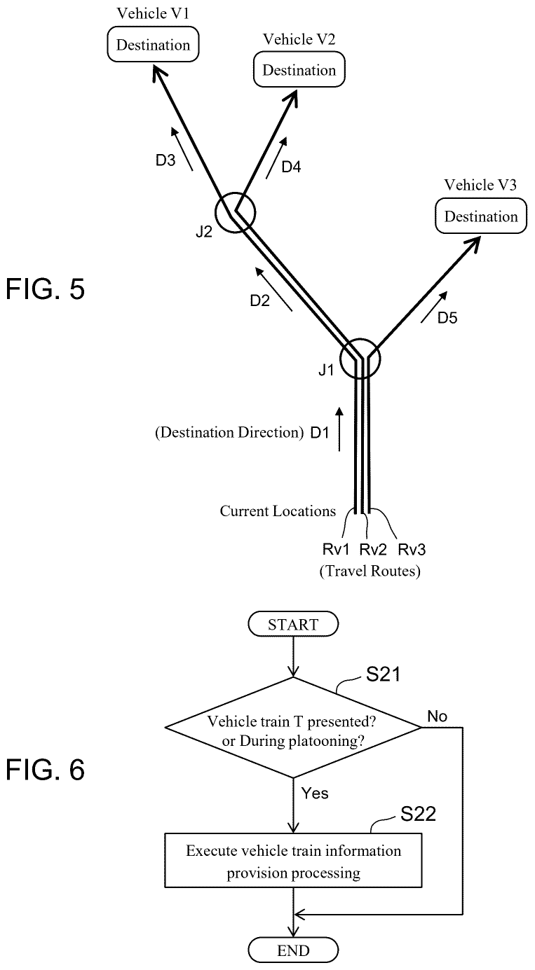

Moreover, the HMI device 15 may include a processor configured to generate a travel route Rv of the vehicle 10 based on the position information on the current location and the destination of the vehicle 10 and the map information. Also, the information on the desired destination as the destination preference information Ipv2 may be a “destination direction (for example, see FIG. 5 described below)” specified by the travel route Rv to the destination.

### (Desired Travel Speed)

The travel speed preference information Ipv3 in each of the vehicles 10 may be acquired in advance by, for example, the following method. That is, the control device 14 may request the occupant 2 to select (input) a desired travel speed through the HMI device 15. More specifically, the control device 14 may request the occupant 2 to input a numerical value of the desired travel speed (for example, 80 km/h, 100 km/h). Alternatively, the control device 14 may request the occupant 2 to select a desired travel speed as a rough speed range (for example, low speed, medium speed, high speed) instead of a specific numerical value (i.e., a set speed) of the desired travel speed. Then, the control device 14 may store the desired travel speed input (selected) by the occupant 2 in the memory device 17 as the travel speed preference information Ipv3. Alternatively, for example, the control device 14 may specify the desired travel speed based on the travel record of the vehicle 10 during the past driving by the occupant 2 and store the specified desired travel speed in the memory device 17 as the travel speed preference information Ipv3.

### (Others)

The travel preference information Ipv may include information indicating a preference of the occupant 2 regarding other elements other than the desired travel pattern, the desired destination, and the desired travel speed. The other elements may be, for example, characteristics of the vehicles 10 constituting the vehicle train T. More specifically, the travel preference information Ipv may include, for example, information indicating a preference for platooning in which only vehicles 10 of the same type (e.g., trucks or passenger cars) are included, and a preference for platooning in which vehicles 10 of different types are allowed to be mixed. Furthermore, the other elements may be, for example, vehicle-to-vehicle information (more specifically, vehicle-to-vehicle time or vehicle-to-vehicle distance) with the preceding and following vehicles 10 during the platooning, and thus the travel preference information Ipv may include information indicating a preference regarding the length of the vehicle-to-vehicle time or the vehicle-to-vehicle distance.

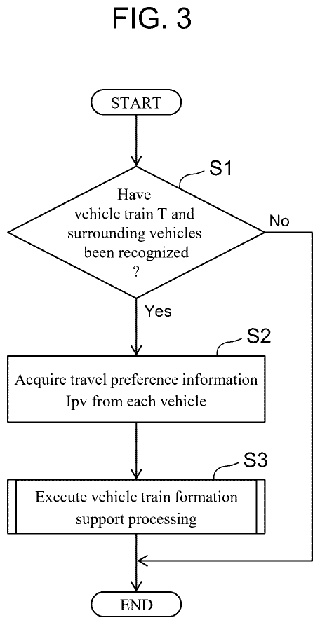

FIG. 3 is a flowchart used to describe the vehicle train formation support processing according to the present embodiment. The processing of this flowchart is executed to support the vehicle 10 having a travel preference close to that of the vehicle train T to join the vehicle train T. When there is a plurality of vehicle trains T, the management server 20 executes the processing of this flowchart for each vehicle train T.

Additionally, the vehicle train T subject to the processing in FIG. 3 is an expression indicating not only a vehicle train (that is, the collection of a plurality of vehicles 10) itself formed after two or more vehicles 10 are first gathered, but also one vehicle 10 served as the center when the two or more vehicles 10 are first gathered for vehicle train formation. The one vehicle 10 serving as the center may be specified as follows, for example. That is, the management server 20 may specify a vehicle having the standard travel preference information Ipv among the two or more vehicles 10 as the one vehicle 10 serving as the center.

In FIG. 3, in step S1, the management server 20 (processor 22) determines whether or not the vehicle train T and one or more surrounding vehicles 10 of the vehicle train T have been recognized. Specifically, the management server 20 specifies the vehicle train T that is the target of the processing this time based on the vehicle train information It. Then, the management server 20 executes processing of recognizing one or more of surrounding vehicles 10 with respect to the vehicle train T on the basis of, for example, the position information of the specified vehicle train T and the position information of the surrounding vehicles 10 that do not currently form a vehicle train. In addition, the one or more surrounding vehicles 10 may include not only one or more vehicles 10 that are traveling but also one or more vehicles 10 that are stopped at a place, such as a service area.

When one or more surrounding vehicles 10 with respect to the vehicle train T are not recognized (step S1; No), the processing proceeds to “END”. On the other hand, when one or more surrounding vehicles 10 are recognized (step S1; Yes), the processing proceeds to step S2. The processing of steps S2 and S3 may be executed when the management server 20 receives requests from one or more surrounding vehicles 10 requesting to join the vehicle train T, instead of the processing of step S1.

In step S2, the management server 20 acquires the travel preference information Ipv from each of the vehicles 10 constituting the vehicle train T and each of the recognized one or more surrounding vehicles 10. The acquired travel preference information Ipv is stored in the memory device 23. Thereafter, the processing proceeds to step S3.

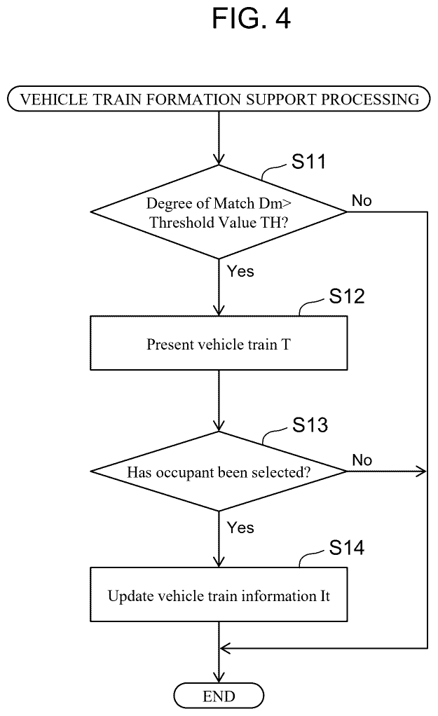

In step S3, the management server 20 executes the vehicle train formation support processing. FIG. 4 is a flowchart showing an example of the flow of the vehicle train formation support processing in step S3. When a plurality of surrounding vehicles 10 are recognized, the processing shown in FIG. 4 is executed for each of the surrounding vehicles 10.

In FIG. 4, in step S11, the management server 20 determines whether or not the degree of match Dm between the travel preference information Ipt of the vehicle train T and the travel preference information Ipv of the surrounding vehicle 10 is higher than a designated threshold value TH. In addition, in step S11, when two or more vehicles 10 are first gathered to form the vehicle train T, the degree of match Dm of the travel preference information Ipv between one vehicle 10 serving as the center of the vehicle train formation and the surrounding vehicle 10 is compared with the threshold value TH.

The degree of match Dm may be quantified in the form of a score SC, for example. For example, the score SC may be calculated to be 0 when the travel preference information Ipt and the travel preference information Ipv completely match each other, and to be greater when the difference between the travel preference information Ipt and the travel preference information Ipv is greater. That is, the degree of match Dm increases when the score SC approaches 0. Therefore, the management server 20 determines that the degree of match Dm is higher than the threshold value TH when the score SC is lower than a designated threshold value.

To be more specific, in an example in which the travel preference information Ipv includes the travel pattern preference information Ipv1, the destination preference information Ipv2, and the travel speed preference information Ipv3, the management server 20 may calculate scores SC1, SC2, and SC3 corresponding to the respective degrees of match Dm1, Dm2, and Dm3, and calculate the sum of the calculated scores SC1, SC2, and SC3 as the score SC. Further, as shown in Equation 1 described below, the scores SC1, SC2, and SC3 may be multiplied by the respective coefficients K (e.g., K1, K2, and K3). Then, the coefficients K may be determined such that the value of one coefficient K corresponding to the preference information of which the degree of reflection on the score SC is desired to be increased is greater than the value of at least one of other coefficients K. For example, in order to increase the degree of reflection of the travel pattern preference information Ipv1 on the score SC, the coefficient K1 may be determined to be greater than at least one of the other coefficients K2 and K3.

$$SC = SC 1 \times K 1 + SC 2 \times K 2 + SC 3 \times K 3 \qquad ( 1 )$$

FIG. 5 is a supplementary diagram regarding the degree of match Dm2 of the destination preference information. FIG. 5 illustrates an example of travel routes Rv1, Rv2, and Rv3 of three vehicles 10 (referred to as vehicles V1, V2, and V3). In FIG. 5, J1 and J2 are junctions at which the vehicle travel directions diverge. In the example illustrated in FIG. 5, the travel route Rv1 includes destination directions D1, D2, and D3, the travel route Rv2 includes destination directions D1, D2, and D4, and the travel route Rv3 includes destination directions D1 and D5. In this example, when viewed from the vehicle V1, it can be said that the preference of “destination direction” (destination preference information Ipv2) of the vehicle V2 having a large number of common destination directions (in other words, having a long platooning available section) is closer to that of the vehicle V1 than that of the vehicle V3. Therefore, in an example in which the information of the destination direction is used as the destination preference information Ipv2, the degree of match Dm2 may be determined as follows, for example. That is, when, for example, the destination preference information Ipt2 of the vehicle train T is equal to the destination preference information Ipv2 of the vehicle V1 in FIG. 5, the degree of match Dm2 between the destination preference information Ipt2 and the destination preference information Ipv2 of the vehicle V2 may be determined to be higher than the degree of match Dm2 between the destination preference information Ipt2 and the destination preference information Ipv2 of the vehicle V3.

The travel preference information Ipt (Ipt1 to Ipt3) of the vehicle train T used in step S11 can be determined as follows based on the travel preference information Ipv (Ipv1 to Ipv3) of the individual vehicles 10 constituting the vehicle train T. That is, for example, a statistical value (for example, a mean value, a variance, or a deviation (an average deviation or a standard deviation)) calculated from the quantified travel preference information Ipv of each of the vehicles 10 constituting the vehicle train T may be used as the travel preference information Ipt of the vehicle train T.

Additionally, the travel pattern preference information Ipt1 of the vehicle train T may be determined as follows. That is, as can be seen from the processing shown in FIG. 4, it can be said that the individual vehicles 10 constituting the vehicle train T have the travel pattern preference information Ipv1 with a high degree of match Dm1. Therefore, when the desired travel pattern is common to all the constituent vehicles 10, the management server 20 may determine the common desired travel pattern (for example, the travel efficiency priority pattern) as the travel pattern preference information Ipt1 (that is, the desired travel pattern of the vehicle train T). Further, even when the desired travel pattern is not common to all the constituent vehicles 10, the management server 20 may determine, as the travel pattern preference information Ipt1, a desired travel pattern that is common to the largest number of constituent vehicles 10 among all the constituent vehicles 10. This is the same for the other destination preference information Ipt2 and the travel speed preference information Ipt3 of the vehicle train T.

In FIG. 4, when the degree of match Dm is equal to or lower than the threshold value TH (step S11; No), the processing proceeds to “END”. That is, the management server 20 excludes the surrounding vehicle 10 that is a target of the determination in step S11 this time from consideration for joining the vehicle train T. In addition, when the management server 20 does not find any of the surrounding vehicles 10 having the degree of match Dm higher than the threshold value TH, the management server 20 may perform the processing illustrated in FIG. 4 again for one or more surrounding vehicles 10 recognized in the processing of step S1 while lowering the threshold value TH.

On the other hand, when the degree of match Dm is higher than the threshold value TH (step S11; Yes), the processing proceeds to step S12. In step S12, the management server 20 presents, to the surrounding vehicle 10 that is a target of the determination in step S11 this time, the vehicle train T as a candidate of vehicle train that the surrounding vehicle 10 joins. The presentation of the vehicle train T is performed for the occupant 2 of the surrounding vehicle 10 through the HMI device 15. The presentation of the vehicle train T is performed, for example, with information necessary for the occupant 2 to determine whether to participate in the vehicle train T. Examples of the information include information on the degree of match Dm of the travel preference information between the vehicle train T and the subject vehicle 10, and information on the time needed for the subject vehicle 10 to reach the vehicle train T.

In step S13 subsequent to step S12, the management server 20 determines whether or not the management server 20 has received intention expression information indicating that the occupant 2 selected to join the vehicle train T from the surrounding vehicle 10 that received the presentation of the vehicle train T.

When the intention expression information is not received within a designated time from the presentation of the vehicle train T (step S13; No), the process proceeds to “END”. On the other hand, when the intention expression information is received (step S13; Yes), the processing proceeds to step S14. In step S14, the management server 20 updates the vehicle train information It such that information of the surrounding vehicle 10 that has transmitted the intention expression information is added.

According to the vehicle train formation support processing described above, it is possible to support the formation of the vehicle train T in which the travel preference of the occupant 2 of each vehicle 10 participating in the vehicle train T is appropriately satisfied. Thus, the occupant 2 of each vehicle 10 can obtain a benefit by participating in the vehicle train T while reducing the degree of sacrificing the travel preference of the occupant 2. In addition, according to the travel preference information Ipv used in the present embodiment, it is possible to support the formation of the vehicle train T while appropriately considering the travel preference of the occupant 2 of each vehicle 10 on the basis of at least one of the desired travel pattern, the desired destination, and the desired travel speed.

Moreover, the processing of step S1 (see FIG. 3) may be executed to recognize a plurality of vehicle trains T. Then, in the vehicle train formation support processing, the management server 20 may specify a plurality of candidates of the vehicle train T to be presented to the occupant 2 of the surrounding vehicle 10 and present the plurality of specified candidates to the occupant 2. Thus, the occupant 2 can select a vehicle train T to be joined from among a plurality of candidates. Therefore, the occupant 2 can more actively select a vehicle train T that more suitably satisfies his/her expectation.

### (Merging Support Processing)

Furthermore, the vehicle train formation support processing may include a “merging support processing” that, after an occupant 2 selects to join a vehicle train T, supports the vehicle 10 of the occupant 2 to travel to join the vehicle train T. Specifically, in an example in which the vehicle 10 is a manually driven vehicle (including the driving assistance vehicle described above), the merging support processing may include, for example, notifying the occupant 2 of at least one of a notification of a travel route until the vehicle 10 joins the vehicle train T, an instruction of lane change, and an instruction of a travel speed, through the HMI device 15. Further, in an example in which the vehicle 10 is the automated driving vehicle described above, the merging support processing may include, for example, that the management server 20 remotely controls the traveling of the vehicle 10 until the vehicle 10 joins the vehicle train T. According to the merging support processing, even when the vehicle 10 selected to join the vehicle train Tis, for example, far from the vehicle train T, the management server 20 that knows the position information of the vehicle 10 and the vehicle train T can smoothly guide the vehicle 10 to the vehicle train T.

### 2-1-1. Vehicle Train Information Provision Processing

Even if information necessary for determining whether to participate in the vehicle train T is provided to a vehicle 10 when the vehicle train T is presented to the vehicle 10 (see step S12), it may be difficult for the occupant 2 of the vehicle 10 to determine whether or not the vehicle train T really matches the travel preference of the subject vehicle 10. In other words, if the occupant 2 of the vehicle 10 cannot know in advance how the platooning will be performed (e.g., travel speed, arrival time at the destination, and lane change frequency) when the vehicle 10 joins the vehicle train T, the travel preference of the occupant 2 may not match the platooning of the vehicle train T after the vehicle 10 actually joins the vehicle train T.

Moreover, when the vehicles 10 are already traveling in a row in the vehicle train T, the way of traveling in a row in the vehicle train T may change, for example, in response to participation of a new vehicle 10 in the vehicle train T or a change in the traveling environment of the vehicle train T. In other words, the traveling state of the vehicle train T may change with the passage of time from the initial formation of the vehicle train T and may not match the travel preference of the occupant 2 of the vehicle 10. Furthermore, the occupant 2 whose travel preference no longer matches that of the vehicle train T may desire to leave the vehicle train T. However, if the occupant 2 cannot accurately know the current traveling state of the vehicle train T, it is difficult for the occupant 2 to appropriately grasp whether or not the traveling state of the vehicle train T matches the travel preference of the occupant 2.

Accordingly, the management server 20 may execute the following “vehicle train information provision processing”. FIG. 6 is a flowchart used to describe an overview of the vehicle train information provision processing according to the present embodiment.

In step S21, the management server 20 determines whether or not the time to present a vehicle train T to a vehicle 10 has come (see step S12) and whether or not vehicles 10 are traveling in a row in the vehicle train T. As a result, when the time to present a vehicle train T has not come or vehicles 10 are not traveling in a row (step S21; No), the processing proceeds to “END”. On the other hand, when the time has come or vehicles 10 are traveling in a row (step S21; Yes), the processing proceeds to step S22.

In step S22, the management server 20 executes the vehicle train information provision processing. To be specific, the management server 20 provides the vehicle train information It regarding the vehicle train T to the vehicle 10 that is a target of the determination in the processing of step S21, through the HMI device 15 of the vehicle 10.

The provided vehicle train information It may include, for example, the current vehicle train travel information Itt. Examples of the current vehicle train travel information Itt include the number of vehicles 10 forming (i.e., constituting) the vehicle train T, the travel speed, the lane change frequency, the travel preference information Ipt for the vehicle train T, and the statistical value of the travel preference information Ipv of the vehicles 10 constituting the vehicle train T. An example of the statistical value is a variance or a mean value of the values of the respective kinds of travel preference information Ipv1 to Ipv3. More specifically, the travel preference information Ipt mentioned here is a value used for the actual platooning of the vehicle train T. Examples of the value include a desired travel speed used as a target speed of the vehicle train T, and a desired destination used as a destination of the vehicle train T.

Furthermore, the provided vehicle train information It may include information on the operation of the vehicle train T. Examples of the information include: an estimated arrival time of the vehicle train T at the destination of the vehicle train T; at least one of a platooning available section on a travel route to the destination of the vehicle 10 that is a target of the provision of the information and a final point of the section; an estimated passage time at a point on the travel route; and at least one of a time and a distance from the formation of the vehicle train T.

According to the vehicle train information provision processing described above, it is possible to provide information useful for the occupant 2 to more comfortably use the platooning, with the vehicle 10 that is about to join the vehicle train T or the vehicle 10 that is already traveling in a row in the vehicle train T.

### 2-2. Travel Management Processing

FIG. 7 is a diagram used to describe an overview of an issue during traveling of the vehicle 10 and travel management processing as a countermeasure against the issue. FIG. 7 illustrates a road having a specific lane Ls (for example, a dedicated lane or a priority lane) in which a specific type of vehicle (for example, a truck or a bus) preferentially travels. In addition, FIG. 7 illustrates travel lanes L1 and L2 together with the specific lane Ls. The travel lane L1 is adjacent to the specific lane Ls, and the travel lane L2 is adjacent to the travel lane L1 on the opposite side of the specific lane Ls. FIG. 7 illustrates, as examples of vehicles traveling in the travel lanes L1 and L2, vehicles 10 that are targets of the support by the travel support system 1 and vehicles Vy that are not targets of the support.

The vehicles 10 may travel in a row on a road having the specific lane Ls, but the specific lane Ls is not always used by the specific type of vehicle Vx. That is, as exemplified on the left side in FIG. 7, a situation is assumed in which travel lanes (for example, L1 and L2) other than the specific lane Ls are congested but only the specific lane Ls is vacant. This kind of situation can also be considered as potentially causing waste in the traffic capacity of the entire road. In addition, it is desirable that the vehicle platooning is performed while satisfying the increase in the benefit of the entire society by forming a vehicle train.

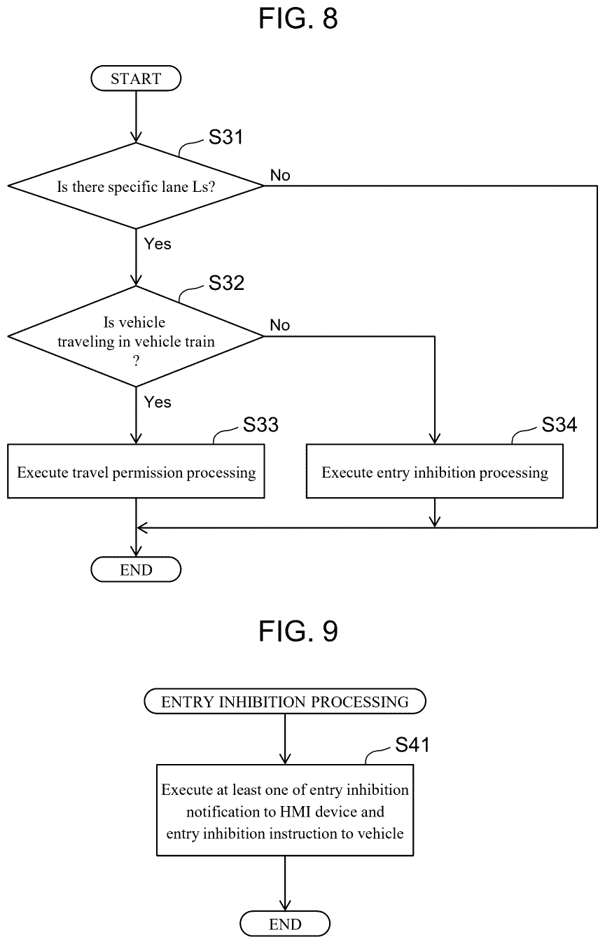

Accordingly, in the present embodiment, the management server 20 (processor 22) executes the “travel management processing” as follows. FIG. 8 is a flowchart showing an example of the flow of the travel management processing according to the present embodiment. The processing illustrated in FIG. 8 is executed, for example, for each vehicle 10 that is traveling.

In step S31, the management server 20 determines whether or not there is a specific lane Ls in a road on which the vehicle 10 is traveling (more specifically, a section of the road on which the vehicle 10 is currently traveling). Specifically, the management server 20 determines whether or not there is a specific lane Ls based on the vehicle information Iv (position information) and the map information (lane information) acquired from the vehicle 10, for example. As a result, when there is no specific lane Ls (step S31; No), the processing proceeds to “END”. On the other hand, when there is the specific lane Ls (step S31; Yes), the processing proceeds to step S32.

In step S32, the management server 20 determines whether or not the vehicle 10 is traveling in a vehicle train T with one or more other vehicles 10, based on the vehicle train information It. As a result, when the vehicles 10 is traveling in a vehicle train T (step S32; Yes), the processing proceeds to step S33.

In step S33, the management server 20 executes “travel permission processing” included in the travel management processing. That is, as illustrated on the right side in FIG. 7, the management server 20 permits the vehicle 10 to travel in the specific lane Ls on condition that the vehicle 10 is traveling in a vehicle train T. In other words, according to the travel permission processing, the right to travel in the specific lane Ls is given to the vehicle train T to which the vehicle 10 belongs.

To be specific, when the vehicle 10 is a manually driven vehicle (including the driving assistance vehicle described above), the travel permission processing includes, for example, transmitting a notification indicating that the vehicle train T can use the specific lane Ls to the HMI device 15 of the vehicle 10. The notification may be transmitted to the HMI device 15 of each vehicle 10 included in the vehicle train T or may be transmitted only to the HMI device 15 of the lead vehicle 10 of the vehicle train T.

Moreover, when the vehicle 10 is an automated driving vehicle described above, the travel permission processing may include, for example, transmitting information indicating that the vehicle train T can use the specific lane Ls to the control device 14 of the vehicle 10. Furthermore, the travel permission processing may include, for example, transmitting an instruction to the vehicle 10 to change the travel lane of the vehicle train T to the specific lane Ls on condition that the management server 20 determines that the specific lane Ls is vacant based on the vehicle train surrounding situation information Its. More specifically, the instruction may be transmitted to each vehicle 10 included in the vehicle train T, for example. Then, the control device 14 of each vehicle 10 that has received the instruction may control the travel device 13 to make the lane change in accordance with the instruction. Alternatively, the instruction may be transmitted such that the management server 20 directly remotely controls the travel device 13 of each vehicle 10 to make the lane change. The information or instruction described above may be transmitted only to the lead vehicle 10 of the vehicle train T. In addition, even when the vehicle 10 is an automated driving vehicle, the management server 20 may also perform the above-described notification using the HMI device 15 in order to notify the occupant 2 of the vehicle 10 that the specific lane Ls is available.

On the other hand, when the vehicle 10 is not traveling in a vehicle train T (step S32; No), the processing proceeds to step S34. In step S34, the management server 20 executes “entry inhibition processing” included in the travel management processing. That is, since the vehicle 10 does not perform the platooning, the management server 20 inhibits entry of the vehicle 10 into the specific lane Ls. One or more vehicles 10 that are targets of this entry inhibition processing include vehicles 10a and 10b. As illustrated on the right side in FIG. 7, the vehicle 10a is one of vehicles 10 that are traveling alone in a travel lane (for example, L1 or L2) other than the specific lane Ls. The vehicle 10b is one of vehicles 10 that have entered the specific lane Ls without permission and are traveling alone in the specific lane Ls. The management server 20 executes the entry inhibition processing as follows, for example.

### 2-2-1. Various Specific Examples of Entry Inhibition Processing

### (First Example)

FIG. 9 is a flowchart showing the first example of the entry inhibition processing in step S34.

When the vehicle 10 is a manually driven vehicle (including the driving assistance vehicle described above), the entry inhibition processing in step S41 is to transmit a notification (entry inhibition notification) to the HMI device 15 of the vehicle 10 to request the vehicle 10 not to enter the specific lane Ls. The entry inhibition notification is transmitted to both the vehicles 10a and 10b (see FIG. 7). More specifically, the content of the entry inhibition notification is, for example, “The track-dedicated lane cannot be used”. The entry inhibition notification using the HMI device 15 is performed using, for example, at least one of screen display and voice.

The entry inhibition notification may be performed once during a trip of the vehicle 10, for example. Alternatively, the entry inhibition notification may be repeatedly performed every time the travel distance of the vehicle 10 increases by a designated distance or every time the travel time of the vehicle 10 elapses by a designated time. Further, the entry inhibition notification may be performed on condition that the vehicle 10 is traveling in an adjacent lane (for example, L1 in FIG. 7) of the specific lane Ls. That is, the entry inhibition notification may be performed so as to exclude vehicles 10 traveling in a travel lane (for example, L2 in FIG. 7) other than the adjacent lane. Furthermore, the management server 20 may perform the entry inhibition notification, for example, when predicting that the vehicle 10 is about to change lanes from the adjacent lane to the specific lane Ls. The management server 20 may perform the prediction when one of the following conditions is satisfied based on, for example, various kinds of vehicle information Iv acquired from the vehicle 10. That is, for example, the management server 20 may perform the prediction when “recognizing that the lateral position of the vehicle 10 traveling in the adjacent lane has approached the specific lane Ls”, “recognizing that the occupant 2 of the vehicle 10 traveling in the adjacent lane has performed a blinker operation for change the travel lane to the specific lane Ls”, or “recognizing that the vehicle 10 has changed the travel lane from a travel lane (e.g., L2) not adjacent to the specific lane Ls to an adjacent lane (e.g., L1)”.

Furthermore, when the vehicle 10b continues to travel in the specific lane Ls although the entry inhibition notification is performed on the vehicle 10b traveling in the specific lane Ls without permission, the entry inhibition processing may include changing the execution mode of the entry inhibition notification so as to strongly urge the occupant 2 of the vehicle 10b to inhibit the entry. To be specific, when the vehicle 10b continues to travel in the specific lane Ls, the management server 20 may execute at least one of “performing an entry inhibition notification with a warning sound”, “increasing the frequency of the entry inhibition notification”, and “increasing the volume of the entry inhibition notification”, for example.

When the vehicle 10 is an automated driving vehicle described above, the entry inhibition processing in step S41 is to instruct the vehicle 10 not to enter the specific lane Ls (entry inhibition instruction). The entry inhibition instruction is directed to both the vehicle 10a and the vehicle 10b. More specifically, the entry inhibition instruction may include, for example, requesting the control device 14 to exclude the specific lane Ls from the selection target of the travel lane in the automatic travel control of the vehicle 10. Further, the entry inhibition instruction issued to the vehicle 10b that is already traveling in the specific lane Ls may include, for example, requesting the control device 14 of the vehicle 10b to change lanes to leave the specific lane Ls. Alternatively, the entry inhibition instruction to the vehicle 10b may include, for example, directly and remotely controlling the travel device 13 of the vehicle 10b to make a lane change for departing from the specific lane Ls.

Additionally, when the vehicle 10 is an automated driving vehicle, the management server 20 may perform not only the entry inhibition instruction but also the entry inhibition notification for the purpose of notifying the occupant 2 of the vehicle 10.

According to the first example described above, it is possible to reliably inhibit the entry of the vehicle 10 into the specific lane Ls, including the departure of the vehicle 10b traveling in the specific lane Ls from the specific lane Ls.

### (Second and Third Examples)

The entry inhibition processing according to the second and third examples is targeted for the vehicle 10b (see FIG. 7) that is traveling in the specific lane Ls without permission (more specifically, the vehicle 10b that continues to travel in the specific lane Ls alone). The entry inhibition processing according to the second and third examples is to perform “function restriction to restrict a vehicle function F1” when the vehicle 10b is traveling in the specific lane Ls without permission, compared to when the vehicle 10b is not traveling in the specific lane Ls (that is, when the vehicle 10b is traveling in a travel lane other than the specific lane Ls).

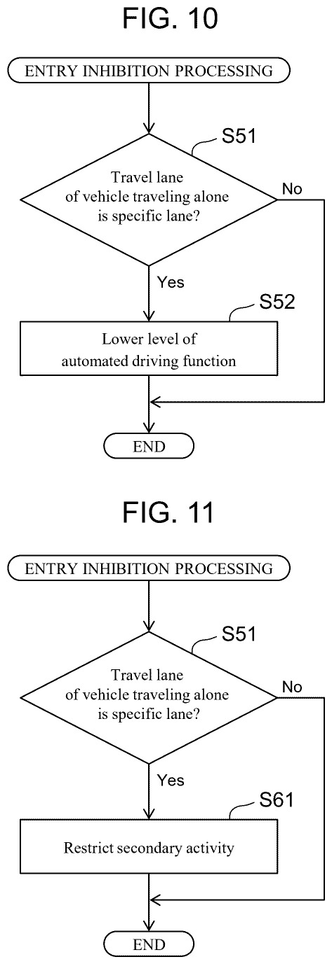

First, FIG. 10 is a flowchart showing the second example of the entry inhibition processing in step S34. In the second example, each of various automated driving functions of the vehicle 10b correspond to the “vehicle function F1”.

In step S51, the management server 20 determines whether or not the travel lane of the vehicle 10 determined to be traveling alone (step S32; No) is the specific lane Ls, for example, based on the vehicle information Iv from the vehicle 10. As a result, when the travel lane of the vehicle 10 is not the specific lane Ls (step S51; No), that is, when the vehicle 10 corresponds to the vehicle 10a (see FIG. 7), the processing proceeds to END. On the other hand, when the travel lane of the vehicle 10 is the specific lane Ls (step S51; Yes), that is, when the vehicle 10 corresponds to the vehicle 10b, the processing proceeds to step S52.

In step S52, the management server 20 instructs, as the function restriction, the control device 14 of the vehicle 10b to lower the level of the automated driving function (i.e., the automatic driving level described above) of the vehicle 10b that is the determination target of step S51. For example, prohibiting the use of a higher-level function (for example, at least one of a hands-off function and an eyes-off function) of an advanced driving assistance system included in the vehicle 10b, which is an automated driving vehicle, corresponds to lowering the automated driving level. Further, in an example of the vehicle 10b, which is a driving assistance vehicle, prohibiting at least one of the ACC and the lane following assistance control described above corresponds to lowering the automatic driving level, for example.

According to the second example described above, the entry inhibition processing is executed, and thus it is possible to take a countermeasure for the occupant 2 in the vehicle 10b to want to depart from the specific lane Ls.

Next, FIG. 11 is a flowchart showing the third example of the entry inhibition processing in step S34. In the third example, the automatic driving function of the vehicle 10b includes the eyes-off function together with the hands-off function. If the eyes-off function is in operation, the occupant (driver) 2 who is released from the driving operation is allowed to perform “secondary activity (for example, viewing of a video (for example, a movie) or a moving image, operation of a mobile terminal, or reading)” which is an action other than the driving operation while the vehicle 10b is traveling. In the third example, a function related to providing the secondary activity (e.g., a media playback function) corresponds to the “vehicle function F1”.

In FIG. 11, when the vehicle 10 determined to be traveling alone corresponds to the vehicle 10b (step S51; Yes), the processing proceeds to step S61. The entry inhibition processing in step S61 is to restrict, as the function restriction described above, the secondary activity of the occupant 2 in the vehicle 10b during the operation of the eyes-off function.

To be specific, the management server 20 instructs the vehicle 10b to control an “in-vehicle device” such that the secondary activity is restricted. The in-vehicle device mentioned here is the HMI device 15 or another device and has a media playback function for viewing a video or a moving image as an example of the vehicle function F1. The control device 14 of the vehicle 10b controls the in-vehicle device such that the use of the media playback function is restricted (for example, the media playback function is disabled), in accordance with an instruction from the management server 20. In addition, the control of the in-vehicle device may be executed along with notifying the occupant 2 that the use of the vehicle function F1 such as the media playback function is restricted, using the HMI device 15.

Even according to the third example described above, the entry inhibition processing is executed, and thus it is possible to take a countermeasure for the occupant 2 in the vehicle 10b to want to depart from the specific lane Ls.

### (Fourth Example)

As in the second and third examples, the entry inhibition processing according to the fourth example is targeted for the vehicle 10b that is traveling in the specific lane Ls without permission (more specifically, the vehicle 10b that continues to travel in the specific lane Ls alone).

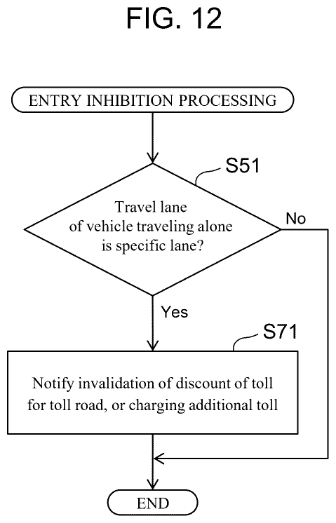

FIG. 12 is a flowchart showing the fourth example of the entry inhibition processing in step S34. In FIG. 12, when the vehicle 10 determined to be traveling alone corresponds to the vehicle 10b (step S51; Yes), the processing proceeds to step S71. The entry inhibition processing in step S71 is to transmit the following notification to the HMI device 15 in the vehicle 10b.

That is, the notification in step S71 indicates that a monetary benefit associated with the execution of the platooning with the vehicle 10b (i.e., a monetary benefit associated with participation of the vehicle 10b in the vehicle train T) is invalidated if the vehicle 10b does not depart from the specific lane Ls, for example, within a designated time. The invalidation of the monetary benefit mentioned here is, for example, that a discount of a toll for a toll road (for example, an expressway), which is scheduled to be obtained if the vehicle 10b joins a vehicle train T and performs the platooning in the toll road, is invalidated.

Furthermore, the notification in step S71 may indicate that an additional toll (a toll for a toll road) is charged to the vehicle 10b if the vehicle 10b does not depart from the specific lane Ls, for example, within a designated time, instead of the above-described invalidation of the monetary benefit.

Even according to the fourth example described above, the entry inhibition processing is executed, and thus it is possible to take a countermeasure for the occupant 2 in the vehicle 10b to want to depart from the specific lane Ls.

As described above, according to the travel management processing of the present embodiment, even the vehicle 10 of a type different from the specific type of vehicle Vx is permitted to travel in the specific lane Ls on condition that the vehicle 10 is traveling in a vehicle train T. If a plurality of vehicles 10 are traveling in a vehicle train T while being managed by the management server 20, it can be said that the behaviors of the plurality of vehicles 10 (that is, the vehicle train T) can be managed in an orderly manner. Therefore, according to the travel management processing, the entire road can be effectively used without disturbing the order. Also, this leads to an increase in the benefit of the entire society by forming a vehicle train.

### 2-2-2. Travel Management Processing in Consideration of Congestion of Specific Lane

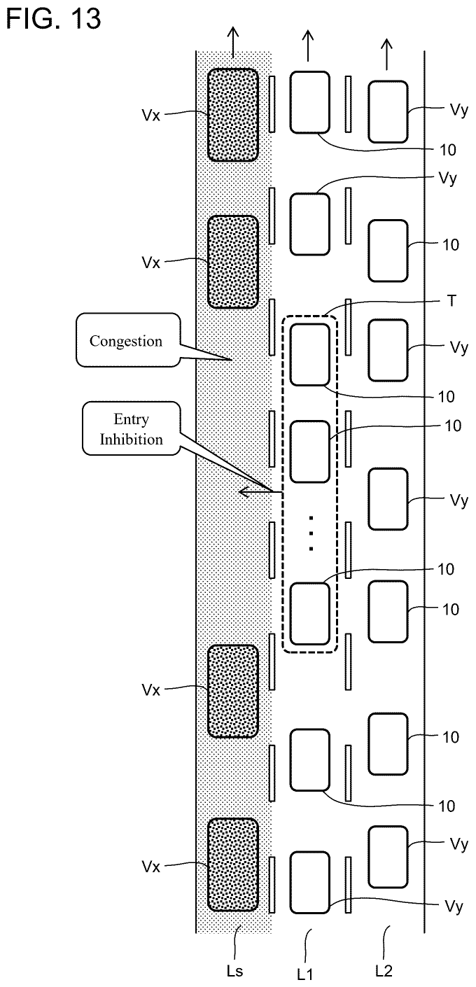

FIG. 13 is a diagram used to describe a further issue during traveling of the vehicle 10 and an execution mode of the travel management processing as a countermeasure against the further issue. According to the travel management processing described above, an effect of reducing the waste of the traffic capacity of the entire road having the specific lane Ls is obtained. On the other hand, as illustrated in FIG. 13, a situation in which the specific lane Ls is congested to some extent by the specific type of vehicles Vx which are the original priority targets is also assumed. If the vehicle train T is permitted to enter the specific lane Ls when the specific lane Ls is congested by the vehicles Vx as described above, smooth traveling of the vehicles Vx in the specific lane Ls may be hindered.

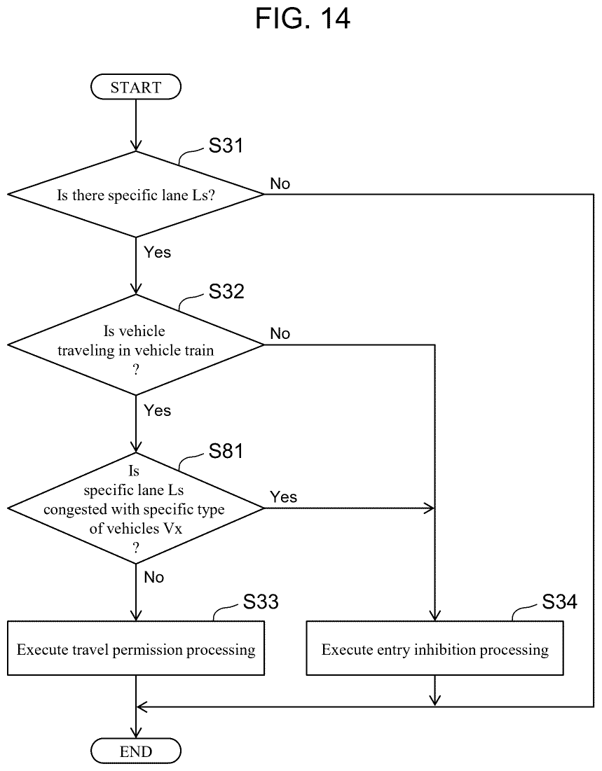

Accordingly, the travel management processing according to the present embodiment may be executed as follows. FIG. 14 is a flowchart showing another example of the flow of the travel management processing according to the present embodiment.

In FIG. 14, when the vehicle 10 is traveling in a vehicle train T on a road having the specific lane Ls (step S32; Yes), the processing proceeds to step S81. In step S81, based on “congestion information Ic on the specific lane Ls”, the management server 20 determines whether or not the specific lane Ls is congested with the specific type of vehicles Vx. This determination can be made as follows, for example.

The congestion information Ic is information on the traffic density (number of vehicles/km) or the traffic volume (number of vehicles/hour) focusing on the vehicles Vx in a designated section of the specific lane Ls. The designated section is a section on the specific lane Ls located around the current position of the vehicle train T to which the vehicle 10 that is a target of the processing this time belongs. The length of the designated section may be constant throughout the road having the specific lane Ls but may be determined so as to change in accordance with the following importance score, for example. This importance score is obtained by scoring the importance of each area of the road having the specific lane Ls in advance. For example, an area with a branching/merging point may be considered to be more important than other areas. Also, in order to more accurately grasp the feature of an area having a high importance, the length of the designated section may be determined to be shorter when the importance score is higher. The traffic density (or the traffic volume) focusing on the vehicles Vx in the designated section determined in this manner may be calculated based on, for example, the vehicle train surrounding situation information Its, the map information (lane information), and the vehicle type information that are described above. The management server 20 determines that the specific lane Ls is congested with the specific type of vehicles Vx when the traffic density (or the traffic volume) calculated in this manner is equal to or greater than a threshold value. In addition, similarly to the length of the designated section, the threshold may also be constant throughout the road having the specific lane Ls but may be determined to be smaller when the importance score is higher, for example.

When the specific lane Ls is not congested with the vehicles Vx (step S81; No), the travel permission processing is executed (step S33). On the other hand, when the specific lane Ls is congested with the vehicles Vx (step S81; Yes), the entry inhibition processing is executed even when the vehicle 10 is traveling in a row in the vehicle train T as shown in FIG. 13 (step S34). In other words, even when the vehicle 10 is traveling in the vehicle train T, the vehicle 10 is not permitted to travel in the specific lane Ls when the specific lane Ls is congested with the vehicles Vx.

According to the travel management processing executed as described above with reference to FIG. 14, when the vehicles Vx that are originally the priority targets are present in the specific lane Ls to, for example, some extent, the entry of the vehicle train T into the specific lane Ls is also inhibited. By considering the use situation of the specific lane Ls by the vehicles Vx in this way, it is possible to appropriately achieve both the maintenance of the smooth traveling environment of the specific lane Ls for the vehicles Vx and the effective use of the entire road without disturbing the order.

### 3. Further Processing Related to Vehicle Traveling Support

For the vehicle traveling support, the management server 20 may additionally execute at least one of “congestion reduction processing”, “first incentive provision processing”, and “second incentive provision processing” described below.

### 3-1. Congestion Reduction Processing

It is known that congestion occurs when the traffic volume of a road is concentrated and exceeds a threshold value, and traffic volume monitoring is performed by a road traffic manager. On the other hand, in terms of reducing the concentration of the traffic volume to reduce the occurrence of congestion, no attention has been paid to the travel control of a vehicle train for the purpose of controlling road traffic flow.

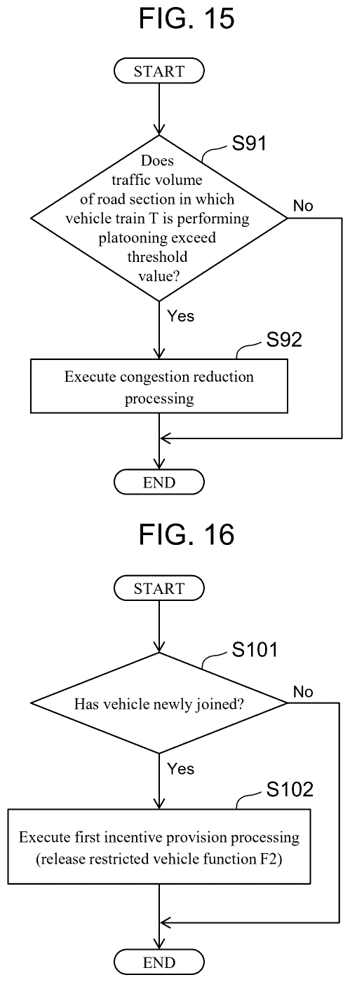

Accordingly, in the present embodiment, the management server 20 may execute the “congestion reduction processing” as follows. FIG. 15 is a flowchart used to describe the congestion reduction processing according to the present embodiment.

In step S91, the management server 20 determines whether or not the traffic volume of a road section in which the vehicle train T including a plurality of vehicles 10 is performing the platooning exceeds a designated threshold value. This determination can be made based on, for example, the vehicle train travel information Itt (position information), the vehicle train surrounding situation information Its (road traffic information), and the map information. This threshold value is determined in advance as a value that can determine that congestion will occur when the traffic volume exceeds the threshold value, for example. When the traffic volume of the road section does not exceed the threshold value (step S91; No), the processing proceeds to “END”. On the other hand, when the traffic volume exceeds the threshold value (step S91; Yes), the processing proceeds to step S92. In addition, this kind of determination of step S91 can be performed in the same manner using the traffic density instead of traffic volume.

In step S92, the management server 20 executes the congestion reduction processing. That is, the management server 20 instructs the vehicle train T to perform at least one of acceleration/deceleration and lane change such that a distance DST between a vehicle group (a surrounding vehicle group) present around the vehicle train T and the vehicle train T increases. The instruction may be given to each of the vehicles 10 included in the vehicle train T, or may be given to only the lead vehicle 10 of the vehicle train T. The management server 20 can calculate a distance DST based on, for example, the vehicle train travel information Itt (position information) and the position information of the surrounding vehicle group. For example, the position information of the surrounding vehicle group may be acquired based on the vehicle train surrounding situation information Its or may be acquired through communication with each vehicle included in the surrounding vehicle group.

More specifically, the surrounding vehicle group that is a target of the congestion reduction processing may be present on one or more travel lanes in any one, two, or three directions of the front, rear, left, and right of the vehicle train T. The congestion reduction processing may be executed based on the vehicle train surrounding situation information Its as follows, for example. That is, when the surrounding vehicle group is present in any one, two, or three directions of the front, rear, left, and right of the vehicle train T, and the remaining one or more directions are vacant, the management server 20 executes at least one of acceleration/deceleration and lane change for moving the vehicle train T in one of the remaining one or more directions in order to increase the distance DST. Hereinafter, some specific examples of the countermeasure (i.e., at least one of acceleration/deceleration and lane change) according to the direction in which the surrounding vehicle group is present will be described.

For example, when a surrounding vehicle group G1 is present behind (or in front of) the vehicle train T, and the front (or rear) of the travel lane of the vehicle train T is vacant, the management server 20 may instruct the vehicle train T to accelerate (or decelerate) such that the distance DST to the surrounding vehicle group G1 increases.

For example, when a surrounding vehicle group G2 is present in a travel lane on the left side (or right side) of the vehicle train T, and the adjacent travel lane on the right side (or left side) of the travel lane of the vehicle train T is vacant, the management server 20 may instruct the vehicle train T to change lanes to the adjacent travel lane on the right side (or left side) such that the distance DST to the surrounding vehicle group G2 increases. In addition, when the front (or rear) of the travel lane of the vehicle train T is vacant, the management server 20 may instruct the vehicle train T to accelerate (or decelerate) such that the distance DST to the surrounding vehicle group G2 increases.

For example, when surrounding vehicle groups G3 and G4 are present behind (or in front of) and on the left side of the vehicle train T, respectively, and there is a space in front of (or behind) the adjacent travel lane on the right side of the travel lane of the vehicle train T, the management server 20 may instruct the vehicle train T to accelerate (or decelerate) and change lanes to the adjacent travel lane such that the distance DST to each of the surrounding vehicle groups G3 and G4 increases.

For example, when surrounding vehicle groups G5, G6, and G7 are present on behind (or in front of) and on the left and right sides of the vehicle train T, respectively, and the front (or rear) of the travel lane of the vehicle train T is vacant, the management server 20 may instruct the vehicle train T to accelerate (or decelerate) such that the distance DST to each of the surrounding vehicle groups G5, G6, and G7 increases.

According to the congestion reduction processing described above, it is possible to appropriately control the road traffic flow so as to reduce the concentration of the traffic volume on the road using the travel control of the vehicle train T. In addition, this kind of travel control of the vehicle train T can affect not only the traveling of the vehicle train T itself but also the traveling of other vehicles traveling around the vehicle train T. Therefore, an effect is also expected that the entire road traffic flow is appropriately controlled such that the concentration of traffic volume is reduced.

### 3-2. Incentive Provision Processing

There may be a merit in the entire road or the entire society by forming a vehicle train. However, if the incentive felt by each vehicle is weak, it is difficult to increase the motivation of the occupant of each vehicle to join the vehicle train. As a result, the vehicle train itself is less likely to be formed. This may miss out on benefits for society as a whole.

### 3-2-1. First Incentive Provision Processing

Accordingly, the management server 20 may execute the “first incentive provision processing” as follows. FIG. 16 is a flowchart used to describe the first incentive provision processing according to the present embodiment.

In step S101, the management server 20 determines whether or not a vehicle 10 has newly joined the vehicle train T based on, for example, the vehicle train information It and the map information. When the vehicle 10 newly joins the vehicle train T, the vehicle train information It is updated (see step S14). Therefore, the management server 20 can determine whether or not a new vehicle 10 has joined the vehicle train T based on the vehicle train information It. When a new vehicle 10 does not join (step S101; No), the processing proceeds to “END”. On the other hand, when a new vehicle 10 joins (step S101; Yes), the processing proceeds to step S102.

In step S102, the management server 20 executes processing (first incentive provision processing) of releasing a “vehicle function F2”, which is restricted during non-execution of the platooning from being used by the vehicle 10 that has joined the vehicle train T, to the vehicle 10 only during execution of the platooning. As a premise, each vehicle 10 that communicates with the management server 20 is configured to be able to switch between restriction and release (that is, invalidation of the restriction) of the vehicle function F2 in response to an instruction from the management server 20.

The vehicle function F2 may include, for example, an automated driving function (including a driving assistance function for supporting driving of the occupant 2 (driver)). The automated driving function may be provided by, for example, the control device 14 that controls the travel device 13 using the sensor group 12. Also, the automated driving function released by the first incentive provision processing may be, for example, a higher-level function (e.g., a hands-off function or an eyes-off function) of an advanced driving assistance system included in the vehicle 10.

Moreover, the vehicle 10 may include a seat having a function of massaging the occupant 2. Also, the vehicle function F2 released by the first incentive provision processing may include the massage function, for example.

Furthermore, the HMI device 15 or one or more other in-vehicle devices mounted on the vehicle 10 may include at least one of a meter display function, an audio function, and a media playback function. Also, the vehicle functions F2 released by the first incentive provision processing may include, for example, at least one of a specific meter display function, a specific audio function, and a specific media playback function (e.g., a media playback function such as viewing a video (for example, a movie) or a moving image at the time of the eyes off).

### 3-2-2. Second Incentive Provision Processing

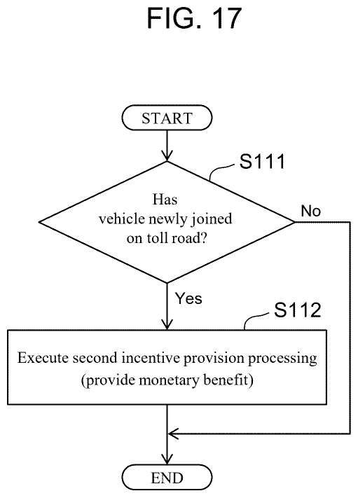

The management server 20 may execute the “second incentive provision processing” as follows, instead of or in addition to the first incentive provision processing. FIG. 17 is a flowchart used to describe the second incentive provision processing according to the present embodiment.

In step S111, the management server 20 determines whether or not a vehicle 10 has newly joined the vehicle train T on a toll road (e.g., an expressway) based on, for example, the vehicle train information It and the map information. As a result, when a new vehicle 10 does not join (step S111; No), the processing proceeds to “END”. On the other hand, when a new vehicle 10 joins (step S111; Yes), the processing proceeds to step S112.

In step S112, the management server 20 executes processing (second incentive provision processing) of providing the occupant 2 of a vehicles 10 that has joined the vehicle train T on the toll road with a “monetary benefit” associated with the use of the toll road.

Specifically, the provision of the monetary benefit to the occupant 2 may include, for example, discounting the usage fee of the toll road of the vehicle 10 that has joined the vehicle train T. More specifically, for example, the discount of the usage fee of the toll road may be performed in accordance with the travel distance of the vehicle 10 during the platooning or may be a discount of the fee of the travel section by the platooning. Further, the provision of the monetary benefit may include a discount on a periodic usage fee of a toll road for a designated period (for example, one month, three months, or six months) on the assumption that the vehicle 10 travels in a vehicle train. Furthermore, the monetary benefit may be provided as a coupon or a point provided in association with the execution of the platooning on a toll road, for example. More specifically, the coupon may be issued, for example, in response to one platooning on a toll road, to discount the usage fee for the next platooning. For example, the point may be given each time the vehicle 10 travels in a vehicle train on a toll road and may have a monetary value that can be used to pay a toll for the toll road.

According to each of the first incentive provision processing and the second incentive provision processing described above, it is possible to favorably increase the incentive to the occupant 2 of each vehicle 10 for forming the vehicle train T (in other words, the motivation of the occupant 2 for each vehicle 10 to form the vehicle train T).

Additionally, in each of the first incentive provision processing and second incentive provision processing. “the vehicle 10 that has joined the vehicle train T” includes not only the vehicle 10 that has newly joined the vehicle train T that has already been formed by a plurality of vehicles 10, but also one of two or more vehicles 10 that initially form the vehicle train T.

What is claimed is:

1. A travel support device that supports vehicle traveling, comprising processing circuitry configured to execute travel management processing when a target vehicle is traveling on a road having a specific lane in which a specific type of vehicle preferentially travels, wherein
the target vehicle is of a different type from the specific type, and
the travel management processing includes:
travel permission processing of permitting the target vehicle to travel in the specific lane when the target vehicle is traveling in a vehicle train being a train of vehicles that perform platooning; and
entry inhibition processing of inhibiting entry of the target vehicle into the specific lane when the target vehicle is not traveling in the vehicle train.

2. The travel support device according to claim 1, wherein
the entry inhibition processing includes at least one of:
transmitting a notification to a human machine interface device of the target vehicle to request the target vehicle not to enter the specific lane; and
instructing the target vehicle not to enter the specific lane.

3. The travel support device according to claim 1, wherein
the entry inhibition processing includes performing function restriction that restricts a vehicle function when the target vehicle is traveling in the specific lane without permission, compared to when the target vehicle is not traveling in the specific lane.

4. The travel support device according to claim 3, wherein
the target vehicle has an automated driving function, and
the function restriction includes lowering a level of the automated driving function.

5. The travel support device according to claim 3, wherein
the target vehicle has an automated driving function including an eyes-off function; and
the function restriction includes restricting a secondary activity of an occupant of the target vehicle during operation of the eyes-off function.

6. The travel support device according to claim 1, wherein
the entry inhibition processing includes transmitting to a human machine interface device of the target vehicle, a notification indicating that a monetary benefit associated with execution of the platooning with the target vehicle is invalidated if the target vehicle does not depart from the specific lane, or a notification indicating that an additional toll is charged if the target vehicle does not depart from the specific lane.

7. The travel support device according to claim 1, wherein
the travel management processing includes:
based on congestion information on the specific lane, determining whether or not the specific lane is congested with the specific type of vehicle; and
when the specific lane is congested with the specific type of vehicle, executing the entry inhibition processing even if the target vehicle is traveling in the vehicle train.

8. The travel support device according to claim 1, wherein
when a traffic volume or a traffic density of a road section in which a vehicle train including the target vehicle is performing the platooning exceeds a threshold value, the processing circuitry instructs the vehicle train to perform at least one of acceleration/deceleration and lane change such that a distance between a vehicle group present around the vehicle train and the vehicle train increases.

9. The travel support device according to claim 1, wherein
after the target vehicle joins a vehicle train, the processing circuitry executes processing of releasing a vehicle function which is restricted during non-execution of the platooning from being used by the target vehicle that has joined, to the target vehicle only during execution of the platooning.

10. The travel support device according to claim 1, wherein
after the target vehicle joins a vehicle train on a toll road, the processing circuitry executes processing of providing a monetary benefit associated with use of the toll road to an occupant of the target vehicle that has joined.

11. The travel support device according to claim 1, wherein
the processing circuitry is configured to:
acquire travel preference information indicating a preference of an occupant regarding vehicle traveling, from each of a plurality of vehicles each corresponding to the target vehicle; and
based on the travel preference information, execute vehicle train formation support processing of supporting formation of a vehicle train in which vehicles included in the plurality of vehicles and having similar preferences perform the platooning, and
the travel preference information includes at least one of travel pattern preference information on a desired travel pattern, destination preference information on a desired destination, and travel speed preference information on a desired travel speed.

12. A travel support method for supporting vehicle traveling, the travel support method, which is executed by a computer, comprising
executing travel management processing when a target vehicle is traveling on a road having a specific lane in which a specific type of vehicle preferentially travels, wherein
the target vehicle is of a different type from the specific type, and
the travel management processing includes:
travel permission processing of permitting the target vehicle to travel in the specific lane when the target vehicle is traveling in a vehicle train being a train of vehicles that perform platooning; and
entry inhibition processing of inhibiting entry of the target vehicle into the specific lane when the target vehicle is not traveling in the vehicle train.

13. A non-transitory computer-readable recording medium storing a travel support program executed by a computer for supporting vehicle traveling,
the travel support program causing the computer to execute travel management processing when a target vehicle is traveling on a road having a specific lane in which a specific type of vehicle preferentially travels, wherein
the target vehicle is of a different type from the specific type, and
the travel management processing includes:
travel permission processing of permitting the target vehicle to travel in the specific lane when the target vehicle is traveling in a vehicle train being a train of vehicles that perform platooning; and
entry inhibition processing of inhibiting entry of the target vehicle into the specific lane when the target vehicle is not traveling in the vehicle train.
